(19) United States
(12) Patent Application Publication
(10) Pub. No.: US 2025/0167605 A1
(43) Pub. Date: May 22, 2025

(54) MOTOR

(71) Applicant: TOYOTA JIDOSHA KABUSHIKI KAISHA, Toyota-shi (JP)

(72) Inventors: Takashi MATSUMOTO, Toyota-shi (JP); Hironori ASAOKA, Okazaki-shi (JP); Masahiro UTSUMI, Toyota-shi (JP); Kenta TABUCHI, Nisshin-shi (JP)

(73) Assignee: TOYOTA JIDOSHA KABUSHIKI KAISHA, Toyota-shi (JP)

(21) Appl. No.: 18/954,752

(22) Filed: Nov. 21, 2024

(30) Foreign Application Priority Data
Nov. 21, 2023 (JP) 2023-197376

(51) Int. Cl. H02K 1/20; H02K 1/16

(52) U.S. Cl. CPC H02K 1/20; H02K 1/16

(57) ABSTRACT

A motor may include: a stator located so that a central axis of the stator intersects with a vertical direction, an annular coolant channel disposed along an end surface of the stator and comprising a ring shape extending around the central axis; and a plurality of individual channels, each of the individual channels being connected to the annular coolant channel, and coolant supplied from the annular coolant channel flowing through the individual channels. The annular coolant channel may include a sectioning structure sectioning the annular coolant channel into an upper channel and a lower channel located below the upper channel. The plurality of individual channels may include a plurality of upper individual channels connected to the upper channel and a plurality of lower individual channels connected to the lower channel.

### REFERENCE TO RELATED APPLICATIONS

This application claims priority from Japanese Patent Application No. 2023-197376 filed on Nov. 21, 2023. The entire content of the priority application is incorporated herein by reference

### TECHNICAL FIELD

The technology disclosed herein relates to a motor.

### BACKGROUND

A motor described in JP-A 2017-204980 has an annular coolant channel along an end surface of a stator. The annular coolant channel has a ring shape extending around a central axis of the stator. The motor also has a plurality of in-stator coolant channels provided within the stator. Each in-stator coolant channel is connected to the annular coolant channel. Coolant flows from the annular coolant channel to each in-stator coolant channel. The motor is cooled by coolant.

### SUMMARY

In JP-A 2017-204980, the annular coolant channel is connected to the in-stator coolant channels. In other motors, another coolant channel (e.g., a channel that discharges coolant toward a coil end of a stator) may be connected to the annular coolant channel. In the following, multiple channels branching from the annular coolant channel will be referred to as individual channels.

When a motor is placed in an orientation where a central axis of the motor intersects a vertical direction (e.g., orientation in which the motor's central axis is horizontal), a height difference is generated inside an annular coolant channel. In this case, pressure is higher at a bottom of the annular coolant channel than at its top. Therefore, more coolant flows into individual channels connected to a lower part of the annular coolant channel than into the individual channels connected to an upper part of the annular coolant channel. Thus, if a flow rate of the coolant is unbalanced among the multiple individual channels, the motor cannot be cooled efficiently. This specification proposes a technique that allows to suppress the imbalance in the flow rate of the coolant between the plurality of individual channels.

A motor disclosed herein according to configuration 1 may comprise: a stator located so that a central axis of the stator intersects with a vertical direction, an annular coolant channel disposed along an end surface of the stator and comprising a ring shape extending around the central axis; and a plurality of individual channels, each of the individual channels being connected to the annular coolant channel, and coolant supplied from the annular coolant channel flowing through the individual channels. The annular coolant channel may comprise a sectioning structure sectioning the annular coolant channel into an upper channel and a lower channel located below the upper channel. The plurality of individual channels may comprise a plurality of upper individual channels connected to the upper channel and a plurality of lower individual channels connected to the lower channel.

An entirety of the lower channel may be located below a lower end of the upper channel, or a portion of the lower channel may be located below the lower end of the upper channel.

The sectioning structure is a structure that divides the upper channel and the lower channel so as to inhibit pressure interaction between the upper channel and the lower channel. The sectioning structure may completely separate the upper channel from the lower channel, or the upper channel and the lower channel may be partially connected in the sectioning structure.

In this motor, the annular coolant channel is sectioned into the upper channel and the lower channel by the sectioning structure. Therefore, it is difficult for pressure to be applied from the upper channel to the lower channel, and the pressure in the lower channel is difficult to increase. Therefore, it is easy for the coolant to flow evenly in the individual channels connected to the upper channel and the individual channels connected to the lower channel. Thus, according to this motor, imbalance in the flow of coolant between multiple individual channels can be suppressed.

### BRIEF DESCRIPTION OF DRAWINGS

FIG. 1 illustrates an exploded view of a motor of a first embodiment.

FIG. 2 illustrates a cross-sectional view of the motor of the first embodiment (cut along an axial direction).

FIG. 3 illustrates a diagram of a stator core of the first embodiment.

FIG. 4 illustrates a plan view of the stator of the first embodiment viewed along the axial direction.

FIG. 5 illustrates an internal structure of a guide ring of the first embodiment (viewed along the axial direction).

FIG. 6 illustrates an internal structure of a guide ring of Variation 1.

FIG. 7 illustrates an internal structure of a guide ring in a second embodiment.

FIG. 8 illustrates an internal structure of a guide ring in a third embodiment.

FIG. 9 illustrates a cross-sectional view of a motor in a fourth embodiment.

FIG. 10 illustrates an internal structure of a guide ring in the fourth embodiment.

FIG. 11 illustrates an internal structure of a guide ring in Variation 2.

FIG. 12 illustrates an internal structure of a guide ring in a fifth embodiment.

FIG. 13 illustrates an internal structure of a guide ring in a sixth embodiment.

FIG. 14 illustrates an internal structure of a guide ring of a seventh embodiment.

FIG. 15 illustrates an internal structure of a guide ring of an eighth embodiment.

FIG. 16 illustrates a cross-sectional view of a motor in Variation 3.

FIG. 17 illustrates a cross-sectional view of a motor in Variation 4.

### DESCRIPTION

Following the first configuration described above, additional configurations of a vehicle disclosed herein will be described below.

(Configuration 2) The motor of configuration 1, wherein the sectioning structure may be a partition wall separating the upper channel from the lower channel, and the motor may further comprise: an upper coolant supply channel configured to supply coolant to the upper channel; and a lower coolant supply channel configured to supply coolant to the lower channel.

(Configuration 3) The motor of configuration 1, wherein the sectioning structure is a partial partition wall reducing a cross section of the annular coolant channel, and the motor further comprises a coolant supply channel configured to supply coolant to the upper channel.

(Configuration 4) The motor of configuration 1, wherein the sectioning structure is a check valve configured to allow coolant to flow from the upper channel to the lower channel and prohibit coolant to flow from the lower channel to the upper channel, and the motor further comprises a coolant supply channel configured to supply coolant to the upper channel.

(Configuration 5) The motor of any of configurations 1 to 4, further comprising a coil wound around the stator, the coil comprising a coil end disposed inside an inner circumference of the annular coolant channel, wherein the plurality of individual channels comprises a plurality of coolant discharge channels configured to discharge coolant toward the coil end.

(Configuration 6) The motor of any of configurations 1 to 4, wherein the plurality of individual channels comprises a plurality of in-stator coolant channels disposed within the stator.

(Configuration 7) A motor, comprising: a stator located so that a central axis of the stator intersects with the vertical direction, an annular coolant channel disposed along an end surface of the stator and comprising a ring shape extending around the central axis; a coil wound around the stator, the coil comprising a coil end disposed inside an inner circumference of the annular coolant channel; and a plurality of coolant discharge channels, each of the coolant discharge channels being connected to the annular coolant channel and configured to discharge coolant supplied from the annular coolant channel toward the coil end, wherein a total of cross-sectional areas of the coolant discharge channels connected to the annular coolant channel above a center position in an up-down direction of the annular coolant channel is larger than a total of cross-sectional areas of the coolant discharge channels connected to the annular coolant channel below the center position.

(Configuration 8) The motor of configuration 7, further comprising a plurality of in-stator coolant channels, each of the in-stator coolant channels being disposed within the stator, each of the in-stator coolant channels being connected to the annular coolant channel, and coolant supplied from the annular coolant channel flowing through the in-stator coolant channels, wherein a total of cross-sectional areas of the in-stator coolant channels connected to the annular coolant channel above the center position is larger than a total of cross-sectional areas of in-stator coolant channels connected to the annular coolant channel below the center position.

In the motor of configuration 8, the total cross-sectional area of the coolant discharge channels connected to the annular coolant channel on the upper side above the center position is larger than the total cross-sectional area of the coolant discharge channels connected to the annular coolant channel on the lower side below the center position. Therefore, even if the pressure in the annular coolant channels is higher on the lower side than on the upper side, the coolant can easily flow evenly in each coolant discharge channel.

In the motor of configuration 9, the total cross-sectional area of the in-stator coolant channels connected to the annular coolant channel on the upper side is larger than the total cross-sectional area of the in-stator coolant channels connected to the annular coolant channel on the lower side below the center position. Therefore, even if the pressure in the annular coolant channel is higher on the lower side than on the upper side, the coolant can easily flow evenly in each in-stator coolant channel.

In Configurations 7 and 8, “cross-sectional area” means the cross-sectional area at a narrowest position of each flow path. For example, if the cross-sectional area of a particular channel varies according to positions in the flow direction, a minimum cross-sectional area of that channel corresponds to the “cross-sectional area” in Configurations 7 and 8.

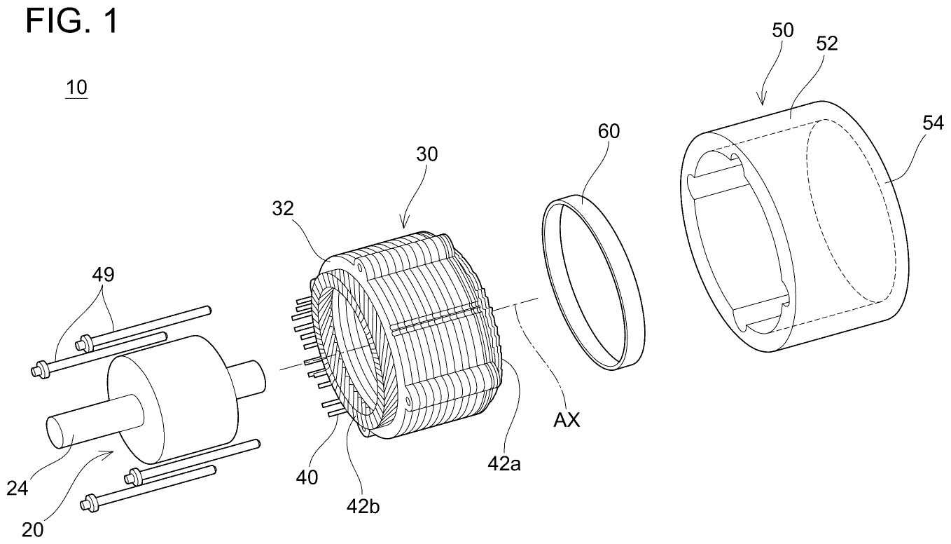

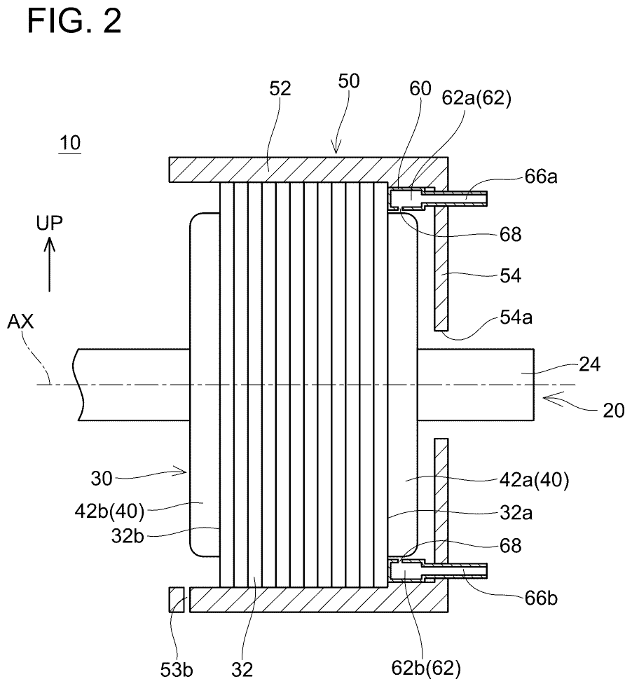

(First Embodiment) A motor 10 of the first embodiment illustrated in FIGS. 1 and 2 comprises a rotor 20, a stator 30, and a case 50. The rotor 20 has a shaft 24. The stator 30 has a cylindrical shape. The rotor 20 is positioned in a center hole of the stator 30 so that a central axis of the shaft 24 and a central axis AX of the stator 30 are aligned. The rotor 20 and the stator 30 are housed in the case 50. The stator 30 is fastened to the case 50 by bolts 49. In the following, a direction parallel to the central axis AX is referred to as an axial direction, a direction along a radius of a circle centering on the central axis AX is referred to as a radial direction, and a direction along a circumference of the circle centering on the central axis AX is referred to as a circumferential direction. An arrow UP in FIG. 2 indicates upward in a vertical direction. The motor 10 is positioned with the central axis AX intersecting the upward direction UP. In FIG. 2, the central axis AX is orthogonal to the upward direction UP. In other words, in FIG. 2, the central axis AX is positioned horizontally. In other examples, the central axis AX may be inclined with respect to a horizontal plane.

As illustrated in FIGS. 1 and 2, the case 50 has a so-called bottomed cylindrical shape and has an outer peripheral wall 52 and a side wall 54. The outer peripheral wall 52 has a cylindrical shape. The side wall 54 is provided at one end of the outer peripheral wall 52 in the axial direction. A through hole 54a is provided in a center of the side wall 54.

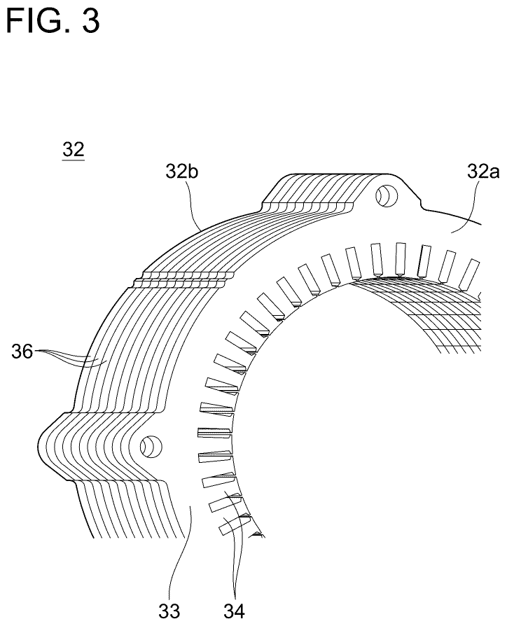

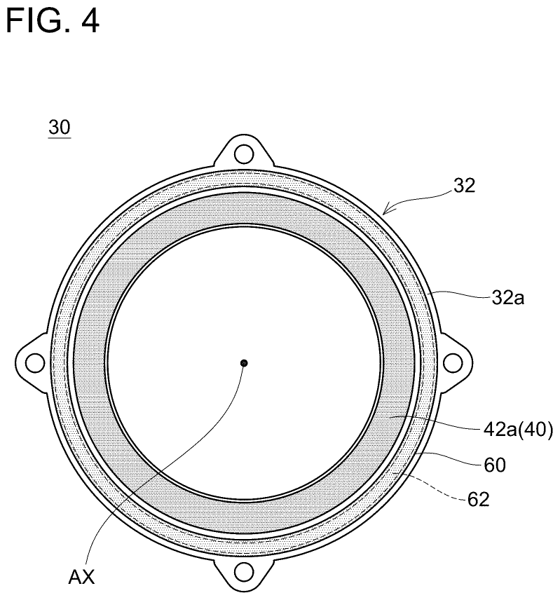

The stator 30 has a stator core 32 and a coil 40. In FIG. 2, the coil 40 is illustrated in simplified form. The stator core 32 has a cylindrical shape. As illustrated in FIG. 3, the stator core 32 is composed of a plurality of electromagnetic steel plates 36 stacked in the axial direction. The stator core 32 has a back yoke 33 and a plurality of teeth 34. The back yoke 33 has a cylindrical shape. Each of the teeth 34 protrudes from an inner surface of the back yoke 33. That is, each of the teeth 34 protrudes from the back yoke 33 inwardly in the radial direction. Each of the teeth 34 extends along the axial direction. The plurality of teeth 34 is spaced apart from each other in the circumferential direction. The coil 40 is wound around each of the teeth 34. The stator core 32 has an end surface 32a and an end surface 32b. The end surface 32a is one end surface of the stator core 32 in the axial direction, and the end surface 32b is the opposite end surface of the end surface 32a. As illustrated in FIG. 2, the end surface 32a has a coil end 42a. The end surface 32b has a coil end 42b. The coil ends 42a and 42b are bent portions of the coil 40 wound around the stator core 32. The coil end 42a protrudes from the end surface 32a, and the coil end 42b protrudes from the end surface 32b. As illustrated in FIG. 4, the coil end 42a is annularly distributed at the end surface 32a. Similarly, the coil end 42b is annularly distributed at the end surface 32b.

As illustrated in FIGS. 1 and 2, the side wall 54 of the case 50 faces the end surface 32a of the stator core 32. A spacing is provided between the side wall 54 and the end surface 32a of the stator core 32, and the coil end 42a is disposed within said spacing.

The rotor 20 is concentric with the stator core 32 and is positioned within the center hole of the stator core 32. The shaft 24 of the rotor 20 is inserted into the through hole 54a of the case 50. The rotor 20 is rotatably supported by bearings or the like in the case 50.

As illustrated in FIGS. 1 and 2, the motor 10 has a guide ring 60. The guide ring 60 has a ring shape. The guide ring 60 is housed in the case 50. The guide ring 60 is arranged to extend annularly around the central axis AX of the stator 30. The guide ring 60 is concentric with the stator core 32 and is disposed between the end surface 32a of the stator core 32 and the side wall 54 of the case 50. The guide ring 60 is fixed to the end surface 32a. An annular coolant channel 62 is provided within the guide ring 60. The annular coolant channel 62 extends along the end surface 32a of the stator core 32. As illustrated in FIG. 4, the annular coolant channel 62 has a ring shape extending around the central axis AX of the stator. The coil end 42a is located inside the guide ring 60 (i.e., the annular coolant channel 62) in the radial direction.

When the motor 10 is operating, coolant flows in coolant channels including the annular coolant channel 62 and cools the motor 10. In this embodiment, the coolant is cooling oil. The cooling oil functions as a coolant to cool the motor 10 and as a lubricant to lubricate the rotor 20.

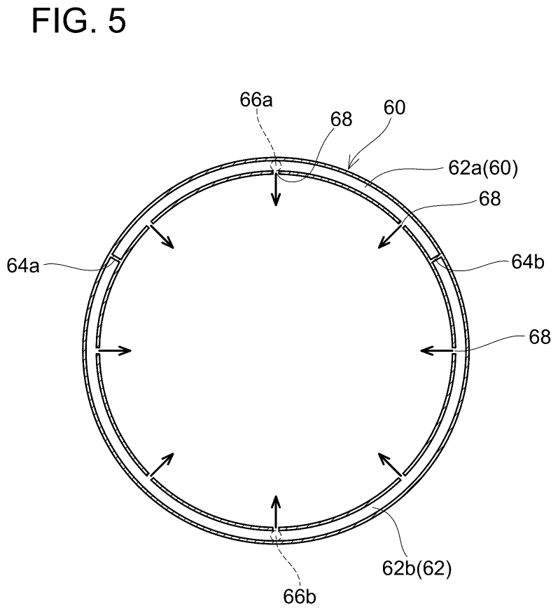

As illustrated in FIGS. 2 and 5, in the first embodiment, a plurality of coolant discharge channels 68 is arranged in the guide ring 60. Each coolant discharge channel 68 is provided in a wall that constitutes an inner surface of the guide ring 60. That is, each coolant discharge channel 68 extends from the annular coolant channel 62 to the inner surface of the guide ring 60. The plurality of coolant discharge channels 68 is provided at substantially equal angular intervals in the circumferential direction. As indicated by arrows in FIG. 5, each coolant discharge channel 68 discharges coolant in the annular coolant channel 62 toward inside of the guide ring 60. As mentioned above, the coil end 42a is located inside the guide ring 60. Therefore, each coolant discharge channel 68 discharges coolant toward the coil end 42a.

As illustrated in FIG. 5, partition walls 64a and 64b are provided inside the annular coolant channel 62. The partition walls 64a and 64b divide the annular coolant channel 62 into an upper channel 62a and a lower channel 62b. The plurality of coolant discharge channels 68 is connected to the upper channel 62a and the lower channel 62b, respectively.

As illustrated in FIGS. 2 and 5, an upper coolant supply channel 66a and a lower coolant supply channel 66b are connected to the guide ring 60. The upper coolant supply channel 66a connects outside of the case 50 to the upper channel 62a. The lower coolant supply channel 66b connects the outside of the case 50 to the lower channel 62b. As illustrated in FIG. 2, a coolant discharge channel 53b is provided at the bottom of the case 50. The coolant discharge channel 53b connects the inside of the case 50 to the outside of the case 50.

When the motor 10 is operating, coolant is supplied to the upper coolant supply channel 66a and the lower coolant supply channel 66b by a pump not illustrated. Coolant flows from the upper coolant supply channel 66a into the upper channel 62a, and from the lower coolant supply channel 66b into the lower channel 62b. The coolant in the upper channel 62a is discharged toward the coil end 42a via the coolant discharge channels 68, and the coolant in the lower channel 62b is discharged toward the coil end 42a via the coolant discharge channels 68. The coolant discharged toward the coil end 42a flows down inside the case 50 and is discharged from the coolant discharge channel 53b to the outside of the case 50. The coolant discharged from the coolant discharge channel 53b is supplied again to the upper coolant supply channel 66a and the lower coolant supply channel 66b by the pump. The motor 10 is cooled by the circulation of the coolant in this manner.

In the first embodiment, since the lower channel 62b is separated from the upper channel 62a by the partition walls 64a and 64b, pressure in the upper channel 62a and pressure in the lower channel 62b are independent from each other. This suppresses the pressure in the lower channel 62b from becoming extremely high relative to the pressure in the upper channel 62a. Therefore, imbalance between the flow rate of the coolant flowing in the coolant discharge channels 68 in the upper channel 62a and the flow rate of the coolant flowing in the coolant discharge channels 68 in the lower channel 62b is suppressed. Therefore, according to the first embodiment, the coil end 42a can be cooled uniformly.

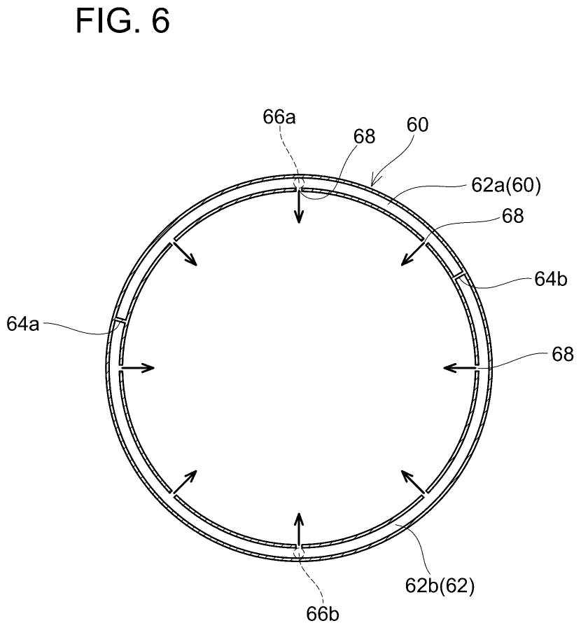

In the first embodiment, the partition walls 64a and 64b are arranged at a same height, but as illustrated in FIG. 6, partition walls 64a and 64b may be arranged at different heights.

(Second Embodiment) In the second embodiment, a sectioning structure that sections an upper channel 62a and a lower channel 62b and coolant supply channels are different from those in the first embodiment. Other configurations in the second embodiment are the same as in the first embodiment.

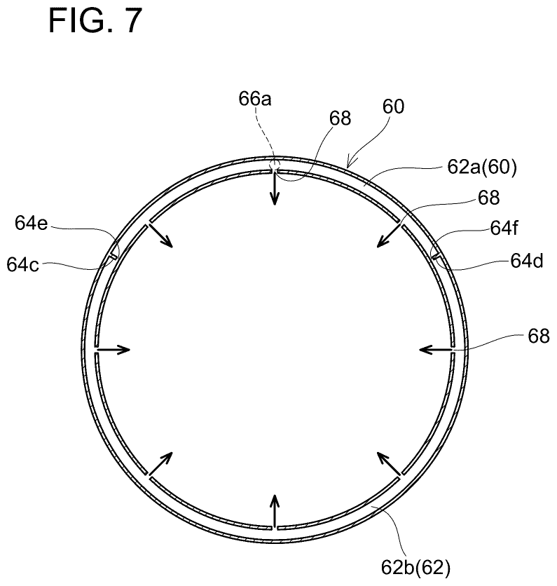

As illustrated in FIG. 7, in the second embodiment, the upper channel 62a and the lower channel 62b are sectioned by partial partition walls 64c and 64d. The partial partition wall 64c partially blocks an annular coolant channel 62, and a micro channel 64e is provided next to the partial partition wall 64c. The micro channel 64e connects the upper channel 62a to the lower channel 62b. The cross-sectional area of the micro channel 64e is smaller than the cross-sectional area of the upper channel 62a and the lower channel 62b. In other words, the partial partition wall 64c reduces the cross-sectional area of the annular coolant channel 62. The partial partition wall 64c may be a diaphragm mechanism such as an orifice. Like the partial partition wall 64c, a partial partition wall 64d also partially blocks the annular coolant channel 62, and a micro channel 64f is located next to the partial partition wall 64d. The micro channel 64f connects the upper channel 62a to the lower channel 62b. The cross-sectional area of the micro channel 64f is smaller than the cross-sectional area of the upper channel 62a and the lower channel 62b.

In the second embodiment, as in the first embodiment, an upper coolant supply channel 66a connected to the upper channel 62a is provided. On the other hand, in the second embodiment, a lower coolant supply channel 66b connected to the lower channel 62b is not provided.

When the motor in the second embodiment is operating, coolant is supplied to the upper channel 62a via the upper coolant supply channel 66a by a pump not illustrated. Since the micro channels 64e and 64f are provided next to the partial partition walls 64c and 64d, the coolant flows from the upper channel 62a to the lower channel 62b via the micro channels 64e and 64f. The coolant in the upper channel 62a is discharged toward the coil end 42a via the coolant discharge channels 68, and the coolant in the lower channel 62b is discharged toward the coil end 42a via the coolant discharge channels 68. Since the upper channel 62a and the lower channel 62b are sectioned by the partial partition walls 64c and 64d, the pressure applied from the upper channel 62a to the lower channel 62b is reduced. This suppresses the pressure in the lower channel 62b from becoming extremely high compared to the pressure in the upper channel 62a. Therefore, imbalance between the flow rate of the coolant flowing in the coolant discharge channels 68 in the upper channel 62a and the flow rate of the coolant flowing in the coolant discharge channels 68 in the lower channel 62b is suppressed. Therefore, according to the second embodiment, the coil end 42a can be cooled uniformly.

(Third Embodiment) In the third embodiment, a sectioning structure that sections an upper channel 62a and a lower channel 62b and coolant supply channels are different from those in the first embodiment. Other configurations in the third embodiment are the same as in the first embodiment.

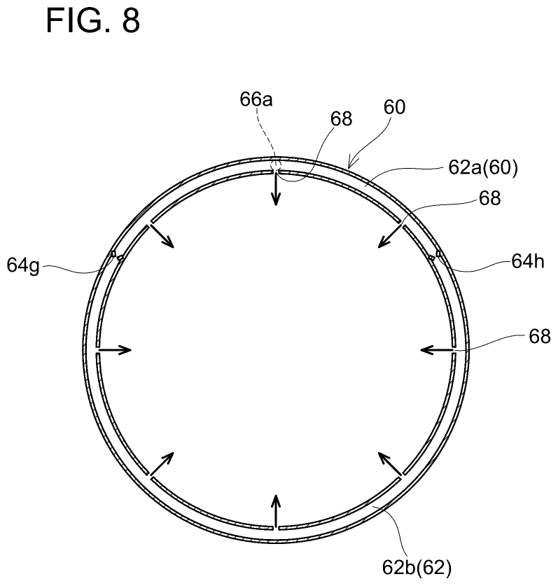

As illustrated in FIG. 8, in the third embodiment, the upper channel 62a and the lower channel 62b are sectioned by check valves 64g and 64h. Each of the check valves 64g and 64h allows the flow of the coolant from the upper channel 62a to the lower channel 62b and prevents the flow of the coolant from the lower channel 62b to the upper channel 62a.

In the third embodiment, as in the second embodiment, an upper coolant supply channel 66a connected to the upper channel 62a is provided, while a lower coolant supply channel 66b connected to the lower channel 62b is not provided.

When the motor in the third embodiment is operating, coolant is supplied to the upper channel 62a via the upper coolant supply channel 66a by a pump not illustrated. The coolant flows from the upper channel 62a to the lower channel 62b via the check valves 64g and 64h. The coolant in the upper channel 62a is discharged toward the coil end 42a via the coolant discharge channels 68, and the coolant in the lower channel 62b is discharged toward the coil end 42a via the coolant discharge channels 68. Since the upper channel 62a and lower channel 62b are sectioned by the check valves 64g and 64h, the pressure applied from the upper channel 62a to the lower channel 62b is reduced. This suppresses the pressure in the lower channel 62b from becoming extremely high compared to the pressure in the upper channel 62a. Therefore, imbalance between the flow rate of the coolant flowing in the coolant discharge channels 68 in the upper channel 62a and the flow rate of the coolant flowing in the coolant discharge channels 68 in the lower channel 62b is suppressed. Therefore, according to the third embodiment, the coil end 42a can be cooled uniformly.

In the first to third embodiments, the coolant discharge channels 68 are an example of individual channels. More specifically, the coolant discharge channels 68 connected to the upper channel 62a are an example of upper individual channels, and the coolant discharge channels 68 connected to the lower channel 62b are an example of lower individual channels.

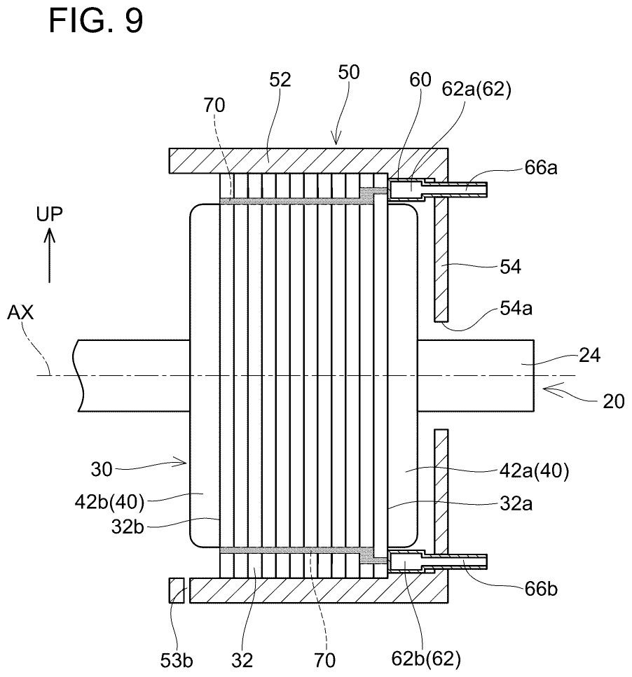

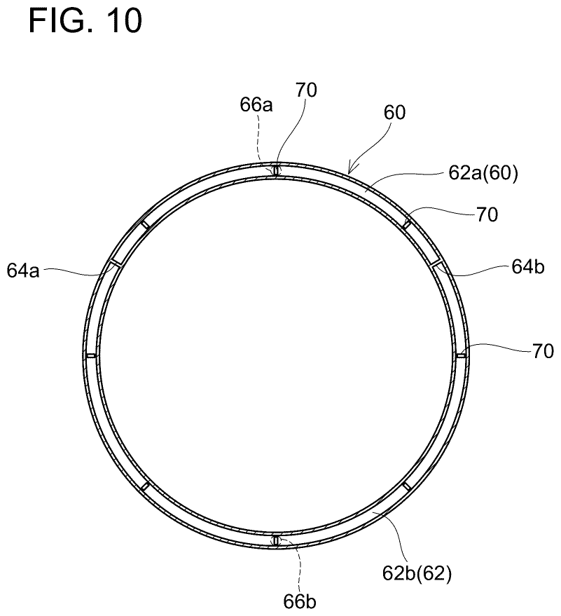

(Fourth Embodiment) As illustrated in FIGS. 9 and 10, in the fourth embodiment, a motor does not have coolant discharge channels 68, but instead has multiple in-stator coolant channels 70. The other configurations of the fourth embodiment are the same as those of the first embodiment. Each in-stator coolant channel 70 is located within the stator core 32. As illustrated in FIG. 9, each in-stator coolant channel 70 extends along the axial direction from one end surface 32a to the other end surface 32b of the stator core 32. An upstream end of each in-stator coolant channel 70 is connected to the annular coolant channel 62. A downstream end of each in-stator coolant channel 70 is open on the end surface 32b. As illustrated in FIG. 10, the upstream ends of the in-stator coolant channels 70 are provided at equal angular intervals in the circumferential direction. Some of the in-stator coolant channels 70 are connected to the upper channel 62a, and some of the in-stator coolant channels 70 are connected to the lower channel 62b.

When the motor in the fourth embodiment is operating, coolant is supplied to the upper coolant supply channel 66a and the lower coolant supply channel 66b by a pump not illustrated. Coolant flows from the upper coolant supply channel 66a into the upper channel 62a and from the lower coolant supply channel 66b into the lower channel 62b. The coolant in the upper channel 62a flows through the in-stator coolant channels 70 and is discharged from their downstream ends (i.e., end surface 32b). The coolant in the lower channel 62b flows through the in-stator coolant channels 70 and is discharged from their downstream ends (i.e., end surface 32b). The coolant flowing in each in-stator coolant channel 70 cools the stator core 32 from the inside. The coolant discharged from the downstream end of each in-stator coolant channel 70 flows down inside the case 50 and is discharged from the coolant discharge channel 53b to the outside of the case 50. The coolant discharged from the coolant discharge channel 53b is supplied again to the upper coolant supply channel 66a and the lower channel 66b by the pump. The motor 10 is cooled by the circulation of the coolant in this manner.

In the fourth embodiment, since the lower channel 62b is separated from the upper channel 62a by partition walls 64a and 64b, pressure in the upper channel 62a and pressure in the lower channel 62b are independent from each other. This prevents the pressure in the lower channel 62b from becoming extremely high relative to the pressure in the upper channel 62a. Therefore, imbalance between the flow rate of the coolant flowing in the in-stator coolant channels 70 connected to the upper channel 62a and the flow rate of the coolant flowing in the in-stator coolant channels 70 connected to the lower channel 62b is prevented. Therefore, according to the fourth embodiment, the stator core 32 can be cooled uniformly.

In the fourth embodiment, the in-stator coolant channels 70 are an example of individual channels. More specifically, the in-stator coolant channels 70 connected to the upper channel 62a are an example of upper individual channels, and the in-stator coolant channels 70 connected to the lower channel 62b are an example of lower individual channels.

In the fourth the fourth embodiment (i.e., FIG. 10), the upper channel 62a and the lower channel 62b are sectioned by the partition walls 64a and 64b, but the sectioning structure of the second embodiment (i.e., partial partition wall) illustrated in FIG. 7 or the sectioning structure of the third embodiment (i.e., check valve) illustrated in FIG. 8 may be applied in the fourth embodiment.

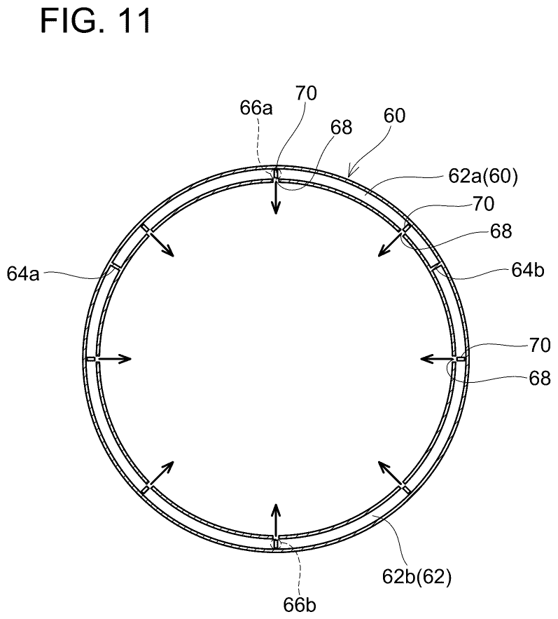

The motor in the fourth embodiment did not have coolant discharge channels 68 while it had an in-stator coolant channel 70. However, as illustrated in FIG. 11, the motor may have both coolant discharge channels 68 and in-stator coolant channels 70. In this case, the same sectioning structure as in the first to fourth embodiments can be used to suppress the flow imbalance between each coolant discharge channel 68 and the flow imbalance between each in-stator coolant channel 70.

(Fifth Embodiment) In the fifth embodiment, the structure of the guide ring 60 differs from that of the first embodiment. As to the other configurations except the guide ring 60, the fifth embodiment is the same as to the first embodiment.

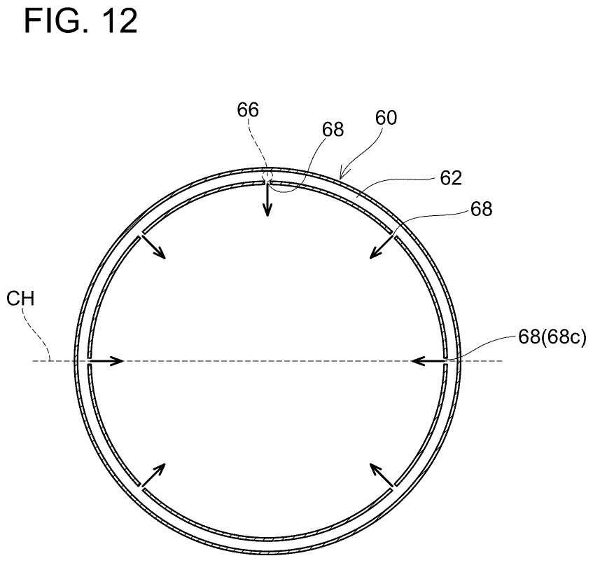

As illustrated in FIG. 12, in the fifth embodiment, the annular coolant channel 62 inside the guide ring 60 does not have a sectioning structure. In other words, the annular coolant channel 62 is connected in an annular shape and has a constant cross-sectional area of the channel over its entire circumference. The coolant supply channel 66 is connected to the guide ring 60. A plurality of coolant discharge channels 68 is provided in the guide ring 60. As in the first embodiment, each coolant discharge channel 68 discharges coolant toward the coil end 42a. Unlike in the first embodiment, in the fifth embodiment, no coolant discharge channel 68 is provided at a lowest part of the annular coolant channel 62. Except for the lowest part, the coolant discharge channels 68 are provided at equal angular intervals in the circumferential direction of the guide ring 60. Therefore, the number of the coolant discharge channels 68 connected to the annular coolant channel 62 in the upper channel above the center position CH (i.e., horizontal line passing through the center of the circle of the annular coolant channel 62) in the vertical direction of the annular coolant channel 62 is larger than the number of coolant discharge channels 68 connected to the annular coolant channel 62 in the lower channel below the center position CH. In addition, the cross-sectional area of each coolant discharge channel 68 is equal. Therefore, the total cross-sectional area of the coolant discharge channels 68 connected to the annular coolant channel 62 at a position above the center position CH is greater than the total cross-sectional area of the coolant discharge channels 68 connected to the annular coolant channel 62 at a position below the center position CH. When there are coolant discharge channels 68c provided at the center position CH as illustrated in FIG. 12, the above total values are calculated by distributing the cross-sectional areas of the coolant discharge channels 68c between the channels above and channels below the center position CH according to its ratio.

When the motor of the fifth embodiment is operating, coolant is supplied to the annular coolant channel 62 via the coolant supply channel 66 by a pump not illustrated. The coolant in the annular coolant channel 62 is discharged from each of the coolant discharge channels 68 toward the coil end 42a. In the fifth embodiment, since the annular coolant channel 62 is not provided with a sectioning structure, the pressure in the annular coolant channel 62 is higher below the center position CH than above the center position CH due to the effect of gravity. On the other hand, as mentioned above, the total cross-sectional area of the coolant discharge channels 68 above the center position CH is larger than the total cross-sectional area of the coolant discharge channels 68 below the center position CH. In other words, an overall channel resistance of the coolant discharge channels 68 above the center position CH is less than an overall channel resistance of the coolant discharge channels 68 below the center position CH. Therefore, even if there is a pressure difference between the part above the center position CH and the part below the center position CH, it is difficult for a difference between the flow rate of the coolant discharged to the coil end 42a above the center position CH and that of the coolant discharged to the coil end 42a below the center position CH to be generated. Therefore, according to the fifth embodiment, the coil end 42a can be cooled uniformly.

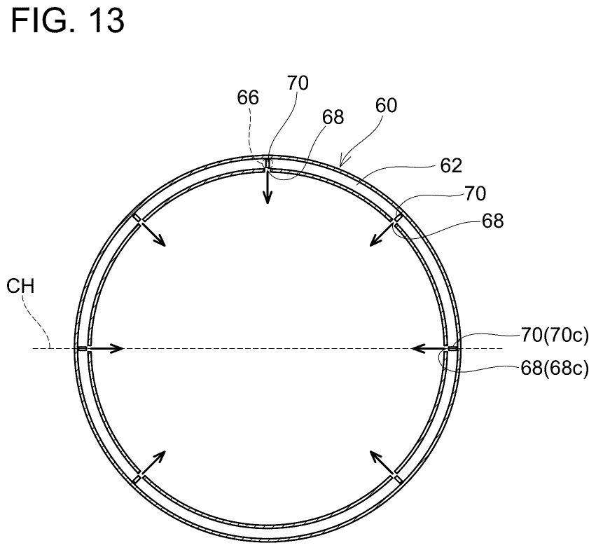

(Sixth Embodiment) As illustrated in FIG. 13, in the sixth embodiment, the motor has the coolant discharge channels 68 in addition to the in-stator coolant channels 70. The other configurations of the sixth embodiment are the same as those of the fifth embodiment. Each in-stator coolant channel 70 passes through the stator core 32 in the axial direction, as in the fourth embodiment (i.e., FIG. 9). As illustrated in FIG. 13, the upstream end of each in-stator coolant channel 70 is connected to the annular coolant channel 62.

In the sixth embodiment, the in-stator coolant channel 70 is not provided at a lowest part of the annular coolant channel 62. Except for the lowest part, the in-stator coolant channels 70 are provided at equal angular intervals in the circumferential direction of the guide ring 60. Therefore, the number of the in-stator coolant channels 70 connected to the annular coolant channel 62 above the center position CH is larger than the number of in-stator coolant channels 70 connected to the annular coolant channel 62 below the center position CH. The cross-sectional area of each in-stator coolant channel 70 is equal. Therefore, the total cross-sectional area of the in-stator coolant channels 70 connected to the annular coolant channel 62 above the center position CH is greater than the total cross-sectional area of the in-stator coolant channels 70 connected to the annular coolant channel 62 below the center position CH. When there are in-stator coolant channels 70c provided at the center position CH, as illustrated in FIG. 13, the above total values are calculated by distributing the cross-sectional area of the in-stator coolant channels 70c between the channels above and the channels below the center position CH according to its ratio.

When the motor in the sixth embodiment is operating, coolant flows in the in-stator coolant channels 70 in addition to the coolant discharge channels 68. In the sixth embodiment, the pressure in the annular coolant channel 62 is higher below the center position CH than above the center position CH due to the effect of gravity. As in the fifth embodiment, imbalance of the coolant flowing in the coolant discharge channels 68 between the channels above and the channels below the center position CH is suppressed, and the coil end 42a is cooled uniformly. In the sixth embodiment, the total cross-sectional area of the in-stator coolant channels 70 above the center position CH is larger than the total cross-sectional area of the in-stator coolant channels 70 below the center position CH. In other words, the overall channel resistance of the in-stator coolant channels 70 above the center position CH is smaller than the overall channel resistance of the in-stator coolant channels 70 below the center position CH. Therefore, even if there is a pressure difference between the part above the center position CH and the part below the center position CH, it is difficult for a difference between the flow rate of the coolant flowing in the in-stator coolant channels 70 above the center position CH and the flow rate of the coolant flowing in the in-stator coolant channels 70 below the center position CH to be generated. Therefore, according to the sixth embodiment, the stator core 32 can be cooled uniformly.

(Seventh Embodiment) In the seventh embodiment, the arrangement and cross-sectional area of the coolant discharge channels 68 is different from those in the fifth embodiment. Other configurations of the seventh embodiment are the same as those of the fifth embodiment.

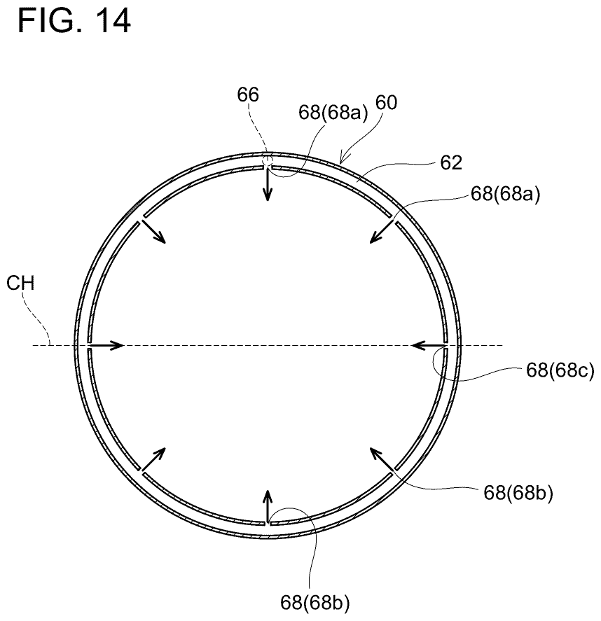

As illustrated in FIG. 14, in the seventh embodiment, the coolant discharge channels 68 are provided at equal angular intervals throughout the circumferential direction of the annular coolant channel 62. Therefore, the number of coolant discharge channels 68 connected to the annular coolant channel 62 above the center position CH is equal to the number of coolant discharge channels 68 connected to the annular coolant channel 62 below the center position CH. In the seventh embodiment, the cross-sectional area of each coolant discharge channel 68a located above the center position CH is larger than the cross-sectional area of each coolant discharge channel 68b located below the center position CH. Therefore, the total cross-sectional area of the coolant discharge channels 68 connected to the annular coolant channel 62 above the center position CH is larger than the total cross-sectional area of the coolant discharge channels 68 connected to the annular coolant channel 62 below the center position CH. The channel resistance of each coolant discharge channel 68a is less than the channel resistance of each coolant discharge channel 68b.

When the motor of the seventh embodiment is operating, the coolant in the annular coolant channel 62 is discharged from each coolant discharge channel 68 toward the coil end 42a. In the seventh embodiment, since no sectioning structure is provided in the annular coolant channel 62, the pressure in the annular coolant channel 62 is higher below the center position CH than above the center position CH due to the effect of gravity. However, since the resistance of the coolant discharge channels 68a located above the center position CH is lower than that of the coolant discharge channels 68b located below the center position CH, even if there is a pressure difference between the part above the center position CH and the part below the center position CH, it is difficult for a difference between the flow rate of the coolant discharged toward the coil end 42a above the center position CH and the flow rate of the coolant discharged toward the coil end 42a below the center position CH to be generated. Therefore, according to the seventh embodiment, the coil end 42a can be cooled uniformly.

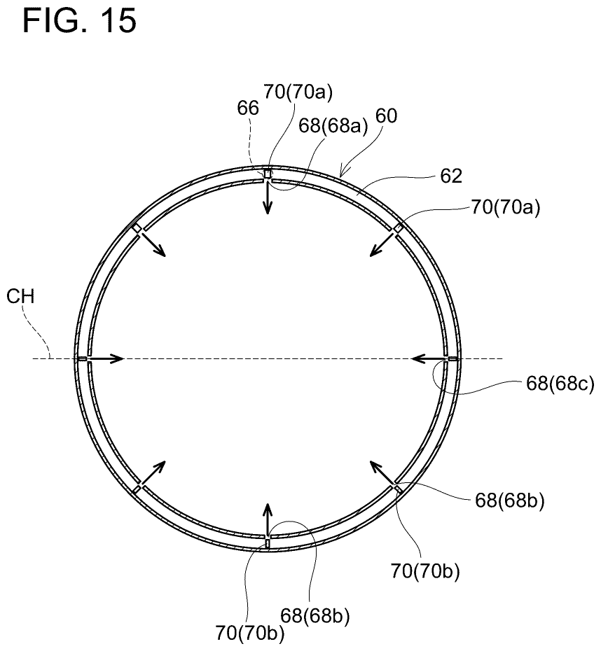

(Eighth Embodiment) As illustrated in FIG. 15, in the eighth embodiment, the motor has coolant discharge channels 68 in addition to in-stator coolant channels 70. The other configurations of the eighth embodiment are the same as those of the seventh embodiment. Each in-stator coolant channel 70 passes through the stator core 32 in the axial direction, as in the fourth embodiment (i.e., FIG. 9). As illustrated in FIG. 15, the upstream end of each in-stator coolant channel 70 is connected to the annular coolant channel 62.

In the eighth embodiment, the in-stator coolant channels 70 are provided at equal angular intervals in the entire circumferential direction of the annular coolant channel 62. Therefore, the number of the in-stator coolant channels 70 connected to the annular coolant channel 62 above the center position CH is equal to the number of the in-stator coolant channels 70 connected to the annular coolant channel 62 below the center position CH. In the eighth embodiment, the cross-sectional area of each in-stator coolant channel 70a located above the center position CH is larger than the cross-sectional area of each in-stator coolant channel 70b located below the center position CH. Therefore, the total cross-sectional area of the in-stator coolant channels 70 connected to the annular coolant channel 62 above the center position CH is larger than the total cross-sectional area of the in-stator coolant channels 70 connected to the annular coolant channel 62 below the center position CH. The channel resistance of each in-stator coolant channel 70a is less than the channel resistance of each in-stator coolant channel 70b.

When the motor of the eighth embodiment is operating, coolant flows in the in-stator coolant channels 70 in addition to the coolant discharge channels 68. In the eighth embodiment, the pressure in the annular coolant channel 62 is higher below the center position CH than above the center position CH due to the effect of gravity. As in the seventh embodiment, imbalance of the coolant flowing in the coolant discharge channels 68 between the channels above and the channels below the center position CH is suppressed, and the coil end 42a is cooled uniformly. In the eighth embodiment, since the channel resistance of the in-stator coolant channels 70a located above the center position CH is smaller than that of the in-stator coolant channels 70b located below the center position CH, even if there is a pressure difference between the part above the center position CH and the part below the center position CH, it is difficult for a difference between the flow rate of the coolant flowing in the in-stator coolant channels 70 located above the center position CH and the flow rate of the coolant flowing in the in-stator coolant channels 70 located below the center position CH to be generated. Therefore, according to the eighth embodiment, the stator core 32 can be cooled uniformly.

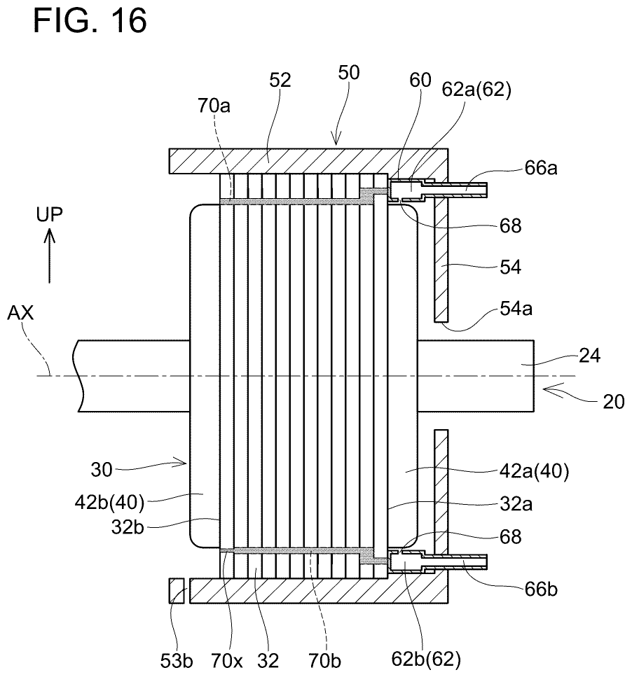

In the eighth embodiment, a difference in cross-sectional area is defined throughout the entire flow direction of each of the in-stator coolant channels 70. However, the channel resistance of each in-stator coolant channel 70 may be adjusted by providing an aperture in a portion of the in-stator coolant channel 70. For example, as illustrated in FIG. 16, by providing an aperture portion 70x with a smaller cross-sectional area at the downstream end of the below in-stator coolant channel 70b, the channel resistance of the below in-stator coolant channel(s) 70b may be greater than that of the above in-stator coolant channel(s) 70a.

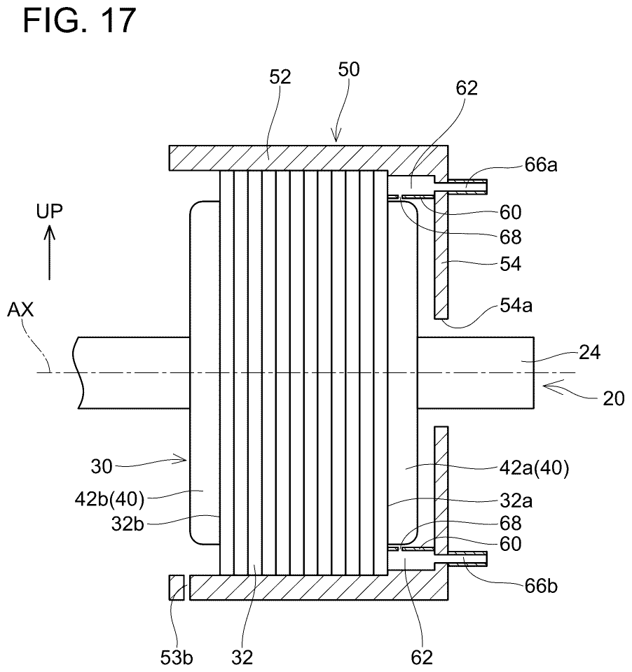

In each of the above embodiments, the annular coolant channel 62 is provided inside the guide ring 60. However, as illustrated in FIG. 17, the guide ring 60 may not have an internal channel, and the annular coolant channel 62 may be formed by an outer circumference of the guide ring 60, the inner surface of the case 50, and the end surface 32a of the stator core 32.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A motor, comprising:
a stator located so that a central axis of the stator intersects with a vertical direction,
an annular coolant channel disposed along an end surface of the stator and comprising a ring shape extending around the central axis; and
a plurality of individual channels, each of the individual channels being connected to the annular coolant channel, and coolant supplied from the annular coolant channel flowing through the individual channels,
wherein the annular coolant channel comprises a sectioning structure sectioning the annular coolant channel into an upper channel and a lower channel located below the upper channel, and
the plurality of individual channels comprises a plurality of upper individual channels connected to the upper channel and a plurality of lower individual channels connected to the lower channel.

2. The motor of claim 1, wherein
the sectioning structure is a partition wall separating the upper channel from the lower channel, and
the motor further comprises:
an upper coolant supply channel configured to supply coolant to the upper channel; and
a lower coolant supply channel configured to supply coolant to the lower channel.

3. The motor of claim 1, wherein
the sectioning structure is a partial partition wall reducing a cross section of the annular coolant channel, and
the motor further comprises a coolant supply channel configured to supply coolant to the upper channel.

4. The motor of claim 1, wherein
the sectioning structure is a check valve configured to allow coolant to flow from the upper channel to the lower channel and prohibit coolant to flow from the lower channel to the upper channel, and
the motor further comprises a coolant supply channel configured to supply coolant to the upper channel.

5. The motor of claim 1, further comprising a coil wound around the stator, the coil comprising a coil end disposed inside an inner circumference of the annular coolant channel,
wherein the plurality of individual channels comprises a plurality of coolant discharge channels configured to discharge coolant toward the coil end.

6. The motor of claim 1, wherein the plurality of individual channels comprises a plurality of in-stator coolant channels disposed within the stator.

7. A motor, comprising:
a stator located so that a central axis of the stator intersects with the vertical direction,
an annular coolant channel disposed along an end surface of the stator and comprising a ring shape extending around the central axis;
a coil wound around the stator, the coil comprising a coil end disposed inside an inner circumference of the annular coolant channel; and
a plurality of coolant discharge channels, each of the coolant discharge channels being connected to the annular coolant channel and configured to discharge coolant supplied from the annular coolant channel toward the coil end,
wherein a total of cross-sectional areas of the coolant discharge channels connected to the annular coolant channel above a center position in an up-down direction of the annular coolant channel is larger than a total of cross-sectional areas of the coolant discharge channels connected to the annular coolant channel below the center position.

8. The motor of claim 7, further comprising a plurality of in-stator coolant channels, each of the in-stator coolant channels being disposed within the stator, each of the in-stator coolant channels being connected to the annular coolant channel, and coolant supplied from the annular coolant channel flowing through the in-stator coolant channels,
wherein a total of cross-sectional areas of the in-stator coolant channels connected to the annular coolant channel above the center position is larger than a total of cross-sectional areas of in-stator coolant channels connected to the annular coolant channel below the center position.
